(19) United States
(12) Patent Application Publication
(10) Pub. No.: US 2006/0098114 A1
(43) Pub. Date: May 11, 2006

(54) Adaptor device and camera system

(75) Inventor: Hirofumi Horii, Asaka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/255,913

(22) Filed: Oct. 24, 2005

(30) Foreign Application Priority Data
Nov. 5, 2004 (JP) 2004-321637

(51) Int. Cl. H04N 5/225

(52) U.S. Cl. 348/360

(57) ABSTRACT

The present invention includes: an optical unit having a photographic optical system through which subject light passes and a first mount connector; a first mount fitting into the first mount connector in a freely attachable and detachable manner; an image pickup device for acquiring image data showing the subject light formed through the photographic optical system; an image transmitting section for transmitting the image data acquired by the image pickup device; an adaptor provided with a second mount connector; an image receiving section for receiving the image data transmitted by the image transmitting section; an image processing section for performing predetermined image processing based on the image data received by the image receiving section; and a second mount fitting into the second mount connector in a freely attachable and detachable manner.

### BACKGROUND OF THE INVENTION

2. Field of the Invention

The present invention relates to an adopter connecting an optical unit to a camera body, the optical unit provided with a photographic optical system, the camera body which the optical unit is attached thereto in a freely attachable and detachable manner and performs predetermined image processing on image data showing subject light formed through the photographic optical system, and also relates to a camera system provided with the optical unit, the adaptor device and the camera body.

2. Description of the Related Art

A lens-interchangeable digital camera which is used by attaching an interchangeable lens to a camera body having a built-in image pickup device has conventionally been known. The lens-interchangeable digital camera has an advantage that it is possible to reuse an interchangeable taking lens conventionally used for a film-type single-lens reflex camera which records a shooting image on a silver-salt film. This is because the subject light formed by the taking lens is received by the image pickup device provided on a camera body side, thus generating shooting image data.

However, if, for example, an expensive large-sized taking lens which is excellent in optical performance is attached to a camera body having a built-in small-sized image pickup device with low resolution, it is not possible to read the subject light with high precision with the image pickup device although the subject light is formed highly precisely with the taking lens. Therefore, there is a problem that it is not possible to take full advantage of the performance of the taking lens.

Regarding this problem, Japanese Patent Application Laid-open No. Hei 8-172561 discloses a head-interchangeable digital camera that a camera head having a built-in taking lens and image pickup device is attached to a camera body. According to a technique described in Japanese Patent Application Laid-open No. Hei 8-172561, it is possible to shoot, while taking advantage of the performance of a taking lens, and to acquire a high-quality shooting image by in advance providing a CCD suitable for the size and optical performance of the taking lens in the camera head.

However, there is a problem in the technique disclosed in Japanese Patent Application Laid-open No. Hei 8-172561 that it is not possible to use a taking lens for a lens-interchangeable camera without an image pickup device, which has conventionally been used, since the image pickup device is provided not on a camera body side but on a camera head side.

### SUMMARY OF THE INVENTION

The present invention has been made in view of the above circumstances and provides a camera system which can use a taking lens for a lens-interchangeable camera without an image pickup device and can acquire a high-quality shooting image while taking advantage of the performance of the taking lens, and an adaptor device composing the camera system.

The adaptor device of the present invention includes: a mount to which an optical unit provided with a photographic optical system is attached in a freely attachable and detachable manner; an image pickup device for acquiring image data which shows the subject light formed through the photographic optical system; an image transmitting section for transmitting the image data acquired by the image pickup device to a camera body which performs predetermined image processing based on the image data; and a mount connector attached to the camera body in a freely attachable and detachable manner.

The adaptor device of the present invention is provided with the image pickup device, and the adaptor device is attached to the camera body in a freely attachable and detachable manner as well as that the optical unit is attached to the adaptor device in a freely attachable and detachable manner. The subject light formed by the photographic optical system provided in an optical member is received by the image pickup device provided in the adaptor device, thus generating image data. The generated image data is transmitted to the camera body, and then the predetermined image processing is performed on the image data in the camera body. Accordingly, it is possible to acquire a high-quality shooting image while taking advantage of the performance of the image pickup device and photographic optical system by choosing the adaptor device having an image pickup device in accordance with the performance of the photographic optical system in the optical unit. In addition, it is also possible to attach an optical unit without an image pickup device, which has conventionally been used for a lens-interchangeable single-lens reflex camera and the like.

Moreover, a camera system of the present invention for achieving the above-mentioned object includes: an optical unit provided with a photographic optical system through which subject light passes and a first mount connector; an adaptor provided with a first mount fitting into the first mount connector in a freely attachable and detachable manner, an image pickup device for acquiring image data which shows the subject light formed through the photographic optical system, an image transmitting section for transmitting the image data acquired by the image pickup device, and a second mount connector; and a camera body provided with an image receiving section for receiving the image data transmitted by the image transmitting section, an image processing section for performing predetermined image processing based on the image data received by the image receiving section, and a second mount fitting into the second mount connector in a freely attachable and detachable manner.

According to the camera system of the present invention, the photographic optical system is provided in the optical unit, and the image pickup device is provided in the adaptor. Hence, it is possible to choose the photographic optical system and the image pickup device separately and to combine them with the camera body. Consequently, it is possible to shoot while taking advantage of the performance of the image pickup device and the photographic optical system. Furthermore, a taking lens which has been used for a conventional lens-interchangeable camera and the like are applied as the optical unit, thus making it possible to reuse these taking lenses.

In addition, it is preferable in the camera system of the present invention that the camera body should have a detecting section for detecting whether what is attached to a second mount is the adaptor or a camera head having the photographic optical system, an image pickup device for acquiring image data which shows the subject light formed through the photographic optical system and the mount connector of the type same as the second mount connector.

By providing the detecting section which detects whether what is attached to the second mount is the adaptor or the camera head, it is possible for a photographer to shoot readily while saving trouble of inputting their types into the camera body.

Further, it is preferable in the camera system of the present invention that the camera body should include an optical unit detecting section for detecting whether the optical unit is attached to the adaptor when the adaptor is attached to the second mount, and a notification section for notifying that the optical unit is unattached when the optical unit is detected to be unattached by the optical unit detecting section.

According to a camera system of an embodiment of the present invention, when the optical unit is not attached, the fact that optical unit is unattached is notified to the photographer. Hence, it is possible to avoid a false operation in which the shooting is performed without the optical unit.

Moreover, it is preferable in the camera system of the present invention that the optical unit should include a storage section for storing optical information relating to the photographic optical system and that the camera body and/or the adaptor include an information acquiring section for acquiring the optical information stored in the storage section.

It is preferable that the camera body and/or the adaptor should include the information acquiring section for acquiring the optical information, since the optical information relating to the photographic optical system such as an f-number becomes necessary when, for example, calculating the depth of field.

It is also preferable in the camera system of the present invention that the adaptor should be provided with a battery which supplies power.

Since the adaptor is provided with the battery, it is possible to pass and receive the optical information and the like between the adaptor and the optical unit before the adaptor is attached to the camera body, thus making it possible to shorten the processing time taken for the shooting.

According to the present invention, it is possible to use a taking lens for a lens-interchangeable camera without an image pickup device, and to provide a camera system which can acquire a shooting image with high image quality while taking advantage of the performance of the taking lens and the image pickup device, and an adaptor device composing the camera system.

### BRIEF DESCRIPTION OF THE DRAWINGS

FIG. 1 is an exploded view of a camera system to which an embodiment of the present invention is applied.

FIG. 2 is an internal block diagram of the camera system 1 shown in FIG. 1.

FIG. 3 is a flowchart showing a sequence of processing till determining the type of a device when a connection detecting section is not provided.

FIG. 4 is a flowchart showing processing until a photographer establishes various settings for the shooting and actually shoots.

FIG. 5 is an internal block diagram of a camera system of a second embodiment of the present invention.

FIG. 6 is an internal block diagram of a camera system of a third embodiment of the present invention.

FIG. 7 is a flowchart showing processing until a photographer establishes various settings for the shooting and actually shoots.

### DETAILED DESCRIPTION OF THE INVENTION

Hereinafter, a description will be given of embodiments of the present invention.

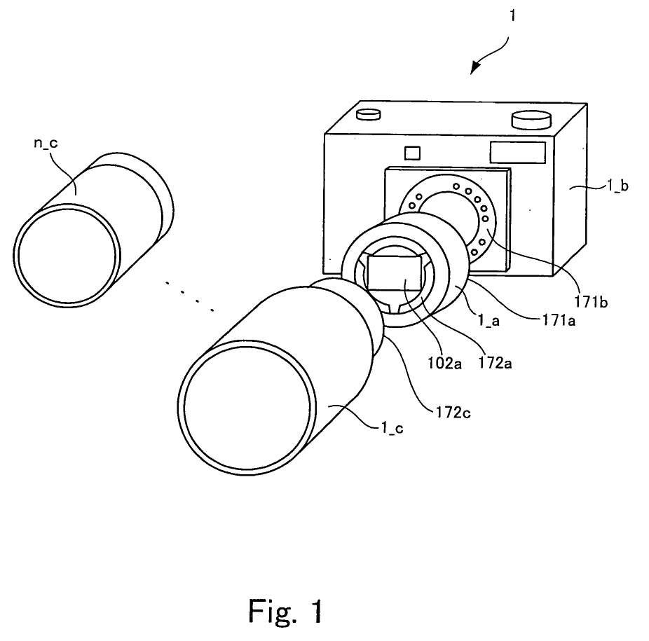

FIG. 1 is an exploded view of a camera system to which an embodiment of the present invention is applied.

Lens units of multiple types, 1_{—}c, 2_{—}c, . . . , n_c, which are provided with taking lenses, are prepared for a camera system 1 shown in FIG. 1. Any one of the multiple types of lens units is chosen out of these multiple types of optical units, and is used. A description will be given, assuming that a first lens unit 1_{—}c is chosen out of the multiple types of lens units 1_{—}c, 2_{—}c, . . . , n_c in the following description.

The camera system 1 is composed of an adaptor 1_{—}a in which a CCD 102a is mounted, a camera body 1_{—}b to which the adaptor 1_{—}a is attached, and the lens unit 1_{—}c to be attached to the adaptor 1_{—}a. This CCD 102a corresponds to an example of an image pickup device according to the present invention, and the adaptor 1_{—}a corresponds to each of examples of an adaptor device and an adaptor according to the present invention. Furthermore, each of the lens units 1_{—}c, 2_{—}c, . . . , n_{—}c corresponds to an example of an optical unit according to the present invention, and the camera body 1_{—}b corresponds to an example of a camera body according to the present invention.

An adaptor mount 172a is provided in the adaptor 1_{—}a. A lens unit mount connector 172c provided on the lens unit 1_{—}c detachably fits into the adaptor mount 172a. In addition, a camera body mount 171b is provided on a front-face side of the camera body 1_{—}b. An adaptor mount connector 171a provided on a side of the adaptor 1_{—}a, which is opposite to the side where the adaptor mount 172a is provided, detachably fits into the camera body mount 171b. The adaptor mount 172a corresponds to an example of a first mount according to the present invention, and the lens unit mount connector 172c corresponds to an example of a first mount connector according to the present invention. Moreover, the camera body mount 171b corresponds to an example of a second mount according to the present invention, and the adaptor mount connector 171a corresponds to an example of a second mount connector according to the present invention.

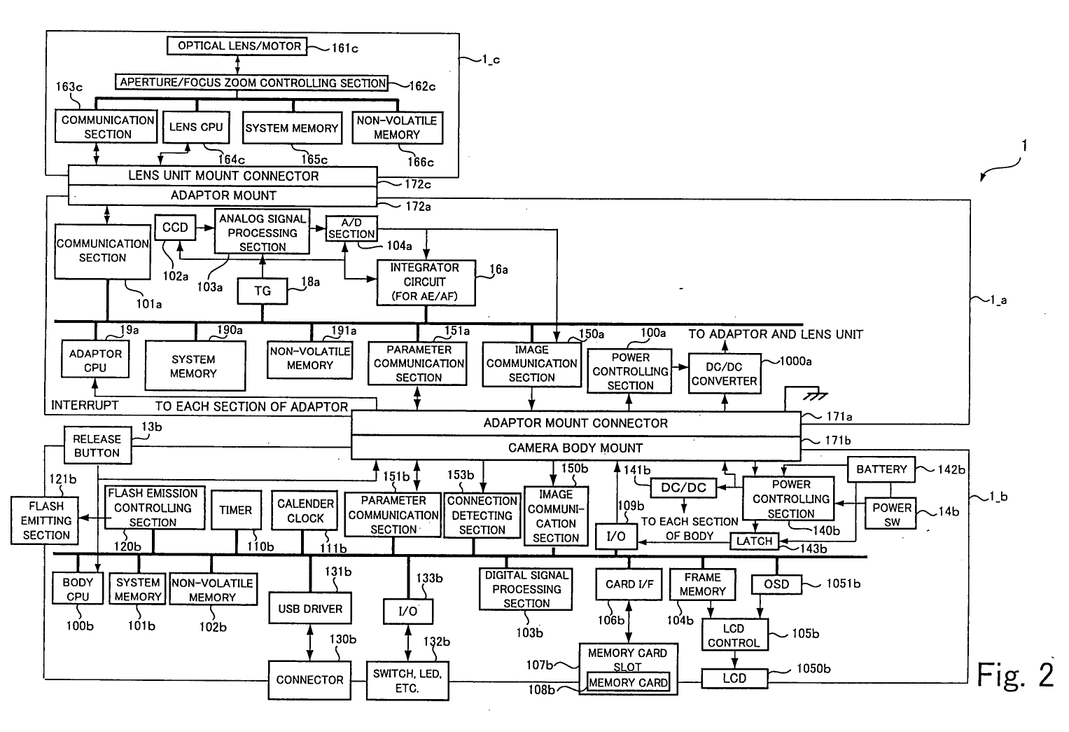

FIG. 2 is an internal block diagram of the camera system 1 shown in FIG. 1.

Firstly, a description will be given of the lens unit 1_{—}c.

The lens unit 1_{—}c includes: an optical member 161c in which various lenses such as a focus lens and a zoom lens, a motor for driving these various lenses and the like are disposed; an aperture/focus zoom control section 162c for controlling the lens positions of the focus and zoom lenses and the aperture by controlling the motor in the optical member 161c; a communication section 163c for transmitting and receiving information in between with the adaptor 1_{—}a; a lens CPU 164c for calculating the lens positions of the focus and zoom lenses based on the information on a focus point and a focal length, which is transmitted from CPU 100b of the camera body 1_{—}b (hereafter referred to as the camera body CPU 100b) as well as controlling various elements of the lens unit 1_{—}c; a system memory 165c used as a temporary memory in a case such as calculation processing at the lens CPU 164c; and a non-volatile memory 166c in which lens parameters such as the f-number of the lens are recorded. The lens unit 1_{—}c is attached to the adaptor 1_{—}a by causing the lens unit mount connector 172c to be fitted into the adaptor mount 172a. The optical member 161c corresponds to an example of the photographic optical system according to the present invention, and the non-volatile memory 166c corresponds to an example of a storage section according to the present invention.

Next, a description will be given of the adaptor 1_{—}a.

The adaptor 1_{—}a includes: various elements which relate to the shooting, such as a communication section 101a for transmitting and receiving information in between with the lens unit 1_{—}c, a CCD 102a for receiving subject light formed through the optical member 161c and generating a subject signal showing the subject light, an analog signal processing section 103a for performing the amplification of the subject signal and gain adjustment, an A/D section 104a for converting the subject signal to be an analog signal into digital image data, a CCD 102a, an analog signal processing section 103a, a timing generator (TG) 18a for emitting a timing signal to the A/D section 104a. This CCD 102a corresponds to an example of an image pickup device according to the present invention.

Here, three types of image data in which a subject image is captured in the field angle at a given moment by receiving the subject light by the CCD 102a are generated, the image data including through image data for a through image shown on an LCD 1050b of the camera body 1_{—}b, still image data showing a still image when a release button 13b is pressed down, and moving image data showing a moving image. The through image data is temporary low resolution data, and is transmitted to an integrator circuit 16a as well as being transmitted to the camera body 1_{—}b.

In addition to the above-mentioned various elements relating to the shooting, the adapter 1_{—}a further includes: the integrator circuit 16a for detecting the brightness (AE detection) and contrast (AF detection) of a subject based on the low resolution image data; an adaptor CPU 19a for controlling the various elements of the adaptor 1_{—}a; a system memory 190a for storing a program which shows processing procedures relating to the AE and AF detection, and the like; a non-volatile memory 191a in which adaptor parameters such as the number of pixels of the CCD 102a are recorded; a parameter communication section 151a for transmitting and receiving the parameters of each type in between with the camera body 1_{—}b; an image communication section 150a for transmitting and receiving image data in between with the camera body 1_{—}b; a power control section 100a for controlling power supplied to the various elements of the adaptor 1_{—}a and the lens unit 1_{—}c; a DC/DC converter 1000a for adjusting power. The image communication section 150a corresponds to an example of an image transmitting section of the present invention.

The adaptor 1_{—}a is attached to the camera body l_{—}b by causing the adaptor mount connector 171a to be fitted into the camera body mount 171b.

Next, a description will be given of the camera body 1_{—}b.

The operation of the camera body 1_{—}b is entirely controlled by the camera body CPU 100b. This camera body 1_{—}b includes: a system memory 101b for storing programs; a parameter communication section 151b for receiving the parameters of each type transmitted from the adaptor 1_{—}a and the lens unit 1_{—}c; an image communication section 151b for receiving image data transmitted from the adaptor 1_{—}a; a non-volatile memory 102b for recording the parameters of each type and the like received by the parameter communication section 151b; a timer 110b for the timer shooting; a calendar clock section 111b for displaying a calendar clock on the LCD 1050b; a USB driver 131b to which a personal computer or the like is connected through a USB connector 130b; a flash emitting section 121b for emitting a flash from a flash emission window provided in the camera body 1_{—}b; a flash emission controlling section 120b for controlling the emission amount in the flash emitting section 121b; a switch/LED 132b operating by being controlled by the camera body CPU through an I/O 133b; a power SW 14b for turning on the power of the camera system 1; a battery 142b for supplying power to this camera system 1; a power controlling section 140b for. controlling power supplied to each element of the camera body 1_{—}b from the battery 142; a DC/DC converter 146b for adjusting power; a latch 143b for maintaining power and transmitting it to the adaptor 1_{—}a and the lens unit 1_{—}c through an I/O 109; a digital signal processing section 103b for performing various processing such as compression processing on the image data received by the image communication section 150b; a frame memory 104b for temporarily recording the through image data received by the image communication section 150b; an LCD controlling section 105b for controlling the display on the LCD 1050b; the LCD 1050b for displaying various menu screens, a through image based on the through image data, and the like; a memory card slot 107b for inserting a memory card 108b which records through a card I/F 106b image data compressed by the digital signal processing section 103b, the image data being generated when shooting. This image communication section 150b corresponds to an example of an image receiving section according to the present invention. The digital signal processing section 103b corresponds to an example of an image processing section according to the present invention.

In addition, in this embodiment, a connection detecting section 153b is provided for detecting whether a device connected to the camera body 1_{—}b is the adaptor 1_{—}a or a camera head having the image pickup device on the lens unit by means of detecting whether what is attached to the camera body mount 171b is the adapter mount connector 171a or a mount connector for a camera head of the same type as the adaptor mount connector 171a. This connection detecting section 153b corresponds to an example of a detecting section according to the present invention.

An adaptor CPU 19a and the camera body CPU 100b, which acquire lens parameters from the lens unit 1_{—}c, correspond to an example of an information acquiring section according to the present invention.

According to the camera system 1 of the embodiment, it is possible to shoot while connecting a lens unit without an image pickup device to the camera body 1_{—}b, since the adaptor 1_{—}a is provided with the CCD 102a. Hence, it is possible to reuse a lens unit for a film-type single-lens reflex camera which is conventionally widely used. Further, it is also possible to shoot while connecting a camera head (a lens unit to which an image pickup device is installed) with the camera body 1_{—}b instead of connecting the adaptor 1_{—}a and the lens unit 1_{—}c as long as the camera head is provided with the same type of mount connector as the adaptor mount connector 171a.

The camera system 1 of the embodiment is basically configured as described above.

A detailed description will hereinafter be given of the flow of information in the camera system 1.

Firstly, a description will be given of the flow of information of when the adaptor 1_{—}a and the camera head are attached to the camera body 1_{—}b.

When a device is attached to the camera body mount 171b of the camera body 1_{—}b, the connection detecting section 153b detects the type of the device, that is, whether the attached device is the adaptor 1_{—}a or the camera head having the same type of mount connector as the adaptor mount connector 171a. Then, the information on the type of the device is transmitted to the camera body CPU 10b. The camera body CPU 100b records the transmitted information on the type of the device in the non-volatile memory 102b.

By providing the connection detecting section 153b in the camera system 1 for detecting the type of the device connected to the camera body 1_{—}b, it is possible to acquire the information on the type of the device before a photographer turns on the power SW 14b and to shorten a processing time from when the power SW 14b is turned on to when the camera system 1 reaches a state where the shooting is possible.

Although here in the camera system 1 of the embodiment the camera body 1_{—}b is provided with the connection detecting section 153b, and a description will be given of a method of acquiring information on the type of a device in a case where the connection detecting section 153b is not provided.

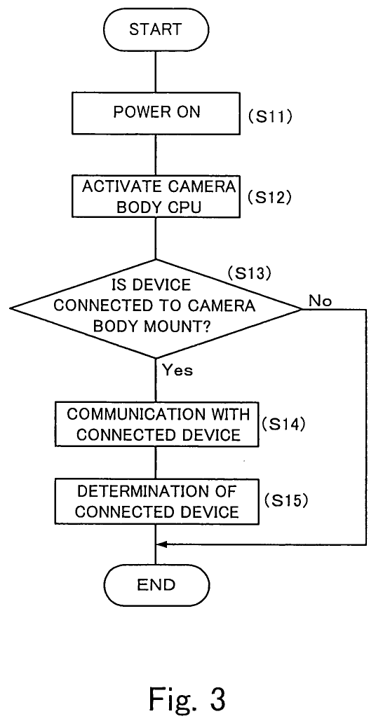

FIG. 3 is a flowchart showing a sequence of processing until the type of a device is determined when the connection detecting section 153b is not provided.

Parameters for device types to determine whether the device is the adaptor or the camera head are previously recorded in the non-volatile memory 191a and the like, which are provided for the adaptor 1_{—}a and the camera head. Here, a description will be given of a case where the adaptor 1_{—}a is connected to the camera body 1_{—}b.

When the photographer turns on the power SW 14b, power is supplied from the battery 142b, thus turning on the camera system 1 (step S11 in FIG. 3).

When the power is turned on, the camera body CPU 100b of the camera body 1_{—}b is activated (step S12 in FIG. 3). The camera body CPU 100b acquires the information on whether or not the device is connected, from the camera body mount 171b (step S13 in FIG. 3). When a device is not connected to the camera body mount 171b (step S13 in FIG. 3: NO), an error message which says “adaptor unattached”is displayed on the LCD 1050b.

Furthermore, when a device is connected to the camera body mount 171b (step S13 in FIG. 3: YES), the non-volatile memory 191a of the adaptor 1_{—}a is accessed (step S14 in FIG. 3) and requests are made to transmit the parameters for device types. The parameters for device types are propagated to the camera body CPU 10Db through the parameter communication section 151a of the adaptor 1_{—}a and the parameter communication section 151b of the camera body 1_{—}b. The camera body 1_{—}b determines the device type based on the propagated parameters for device types (step S15 in FIG. 3).

When the connection detecting section 153b is not provided, the device type is determined as described above. Hereinafter, returning to the embodiment, the description will be continued.

Next, a description will be given of the flow of information to be transmitted and received until the photographer establishes various settings for shooting and then the shooting is actually performed.

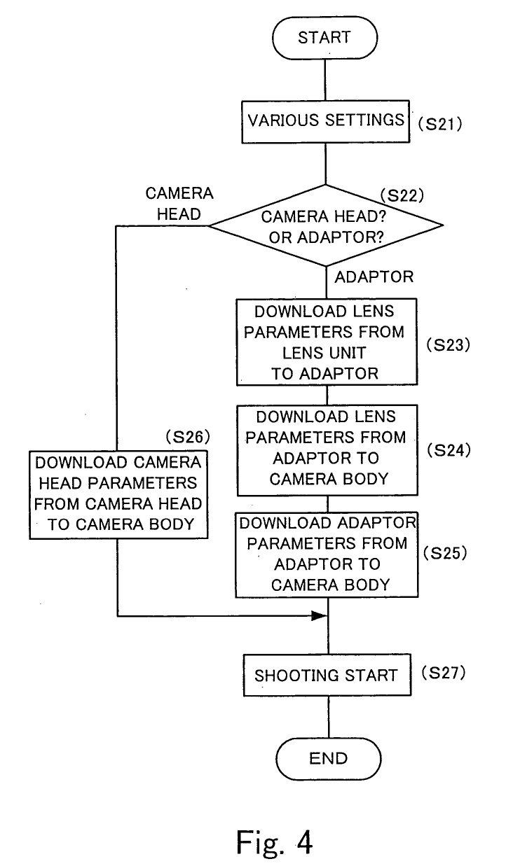

FIG. 4 is a flowchart showing the processing until the photographer establishes various settings for shooting and then the shooting is actually performed.

Adaptor parameters such as the number of pixels of the CCD 102a are previously recorded in the non-volatile memory 191a of the adaptor 1_{—}a. Lens parameters such as f-number of the lens are previously recorded in the non-volatile memory 166c of the lens unit 1_{—}c. Camera head parameters such as the number of pixels of the CCD and the f-number of the lens, which are provided in the camera head, are previously recorded in the non-volatile memory provided in the camera head.

Following the instructions on the menu screen displayed on the LCD 1050b, the photographer establishes settings including a shooting mode such as a landscape shooting mode or a normal shooting mode, the data size of image data and with or without a flash emission (step S21 in FIG. 4). Thus, the preparation for the shooting is started.

When a device connected to the camera body 1_{—}b is a camera head (step S22 in FIG. 4: CAMERA HEAD), the camera body CPU 100b acquires the camera head parameters previously recorded in the volatile-memory, through the parameter communication section provided in the camera head and the parameter communication section 151a of the camera body 1_{—}b (step S26 in FIG. 4).

Moreover, when the device connected to the camera body 1_{—}b is the adaptor 1_{—}a (step S22 in FIG. 4: ADAPTOR), the lens parameters recorded in the non-volatile memory 166c of the lens unit 1_{—}c is firstly recorded in the system memory 190a of the adaptor 1_{—}a through the communication section 163c of the lens unit 1_{—}c and a communication section 101a of the adaptor 1_{—}a (step S23 in FIG. 4). Subsequently, the lens parameters recorded in the system memory 190a of the adaptor 1_{—}a is recorded in the system memory 101b of the camera body 1_{—}b through the parameter communication section 151a of the adaptor 1_{—}a and the parameter communication section 151b of the camera body 1_{—}b (step S24 in FIG. 4).

Furthermore, the adaptor parameters recorded in the non-volatile memory 191a of the adaptor 1_{—}a is recorded in the system memory 101b of the camera body 1_{—}b through the parameter communication section 151a of the adaptor 1_{—}a and the parameter communication section 151b of the camera body 1_{—}b (step S25 in FIG. 4).

As described above, when the parameters of each type are propagated to the camera body 1_{—}b, the camera body CPU 100b gives operational commands to various elements of the camera system 1 in accordance with these parameters of each type, the various setting contents established by the photographer, and the like. Thus, the shooting is started (step S27 in FIG. 4).

Now, the description is finished of the first embodiment of the present invention. Next, a description will be given of a second embodiment of the present invention. The configuration of the camera system 1 of the first embodiment is almost the same as that of a camera system of the second embodiment. Therefore, a description will be omitted of the same elements while allocating the same reference characters, and only different points between the first and second embodiments will be described.

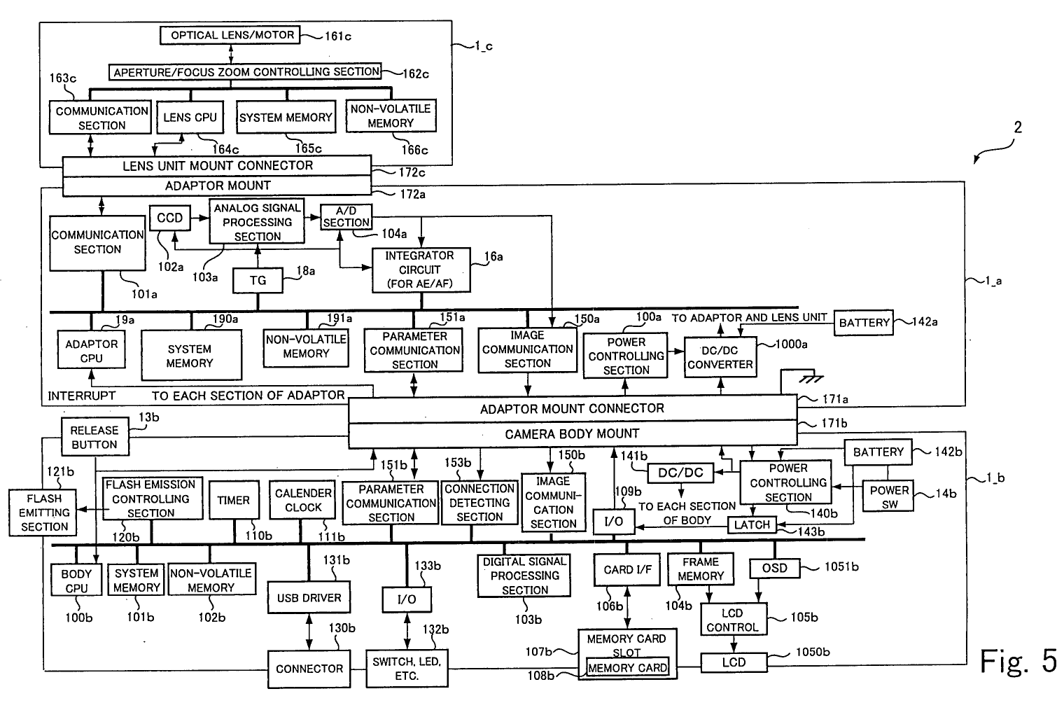

FIG. 5 is an internal block diagram of the camera system 2 of the second embodiment of the present invention.

The camera system 2 of this embodiment shown in FIG. 5 has almost the same configuration as that of the camera system 1 of the first embodiment shown in FIG. 2. However, a different point is that a battery 142a is provided for the adaptor 1_{—}a in the camera system 2 of this embodiment.

The battery 142a supplies power to the adaptor 1_{—}a and the lens unit 1_{—}c. This battery 142a corresponds to an example of a battery according to the present invention.

By providing the battery 142a for the adaptor 1_{—}a, the power for driving the lens mounted in the lens unit 1_{—}c can be added in addition to the power supplied from the battery 142b of the camera body 1_{—}b. Even when the lens unit 1_{—}c in which a large-sized lens is mounted is attached, it is possible to drive the lens. Additionally, even if the adaptor 1_{—}a is not attached to the camera body 1_{—}b, it is possible to activate the adaptor 1_{—}a and the lens unit 1_{—}c by use of the battery 142a of the adaptor 1_{—}a. As a result, it is possible to perform the processing of step S23 of the flowchart in FIG. 4 for propagating the lens parameters to the adaptor 1_{—}a, before the adaptor 1_{—}a is attached to the camera body 1_{—}b. Accordingly, it is possible to shorten the processing time for the shooting preparation. Note that in this case the lens parameters are recorded not in the system memory 190a of the adaptor 1_{—}a but in the non-volatile memory 191a of the adaptor 1_{—}a.

Now the description of the second embodiment of the present invention is finished, and a description will be given of a third embodiment of the present invention. A camera system of the third embodiment of the present invention also has almost the same configuration as those of the camera systems 1 and 2 of the first and second embodiments. Hence, a description will be omitted of the same elements while allocating the same reference characters, and only different points from the first and second embodiments will be described.

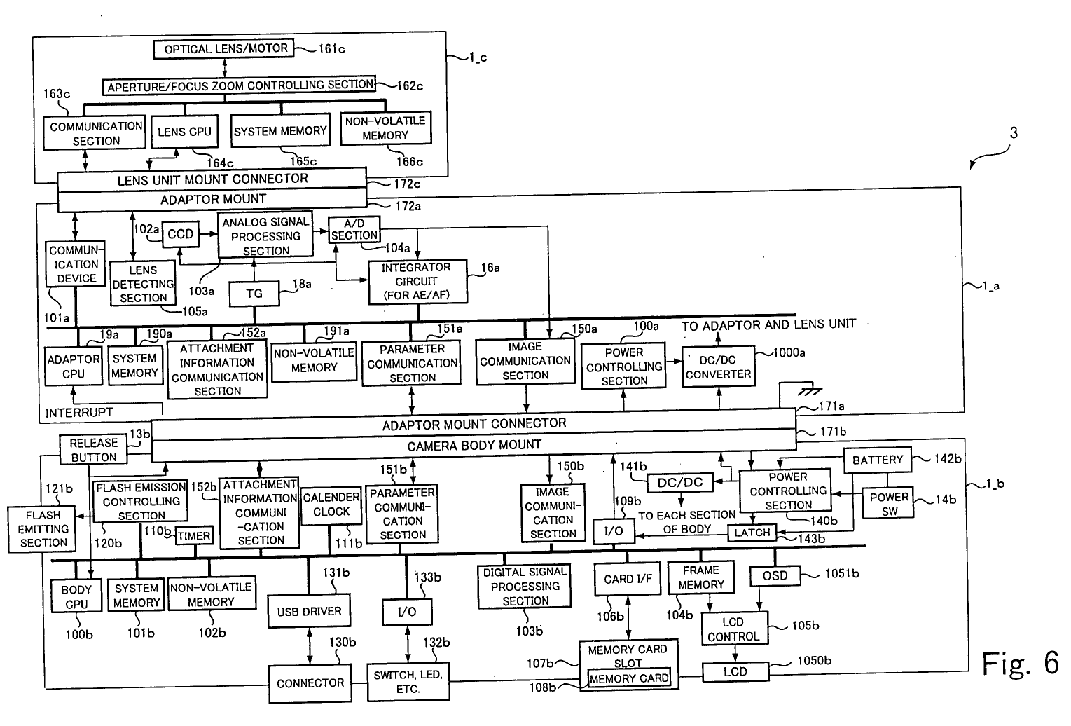

FIG. 6 is an internal block diagram of the camera system 3 of the third embodiment of the present invention.

The camera system 3 of this embodiment shown in FIG. 6 has almost the same configuration as that of the camera system 1 of the first embodiment shown in FIG. 2. However, the connection detecting section 153b, which is provided for the camera system 1 of the first embodiment, is not provided for the camera system 3 of this embodiment. Instead, a lens detecting section 105a for detecting the attachment state of the lens unit 1_{—}c and an attachment information communication section 152a for transmitting the information on the attachment state of the lens unit 1_{—}c are provided for the adaptor 1_{—}a, and an attachment information communication section 152b for receiving the information on the attachment state of the lens unit 1_{—}c from the adaptor 1_{—}a is provided for the camera body 1_{—}b. The LCD 1050b corresponds to an example of a notification section according to the present invention, and the lens detecting section 105a corresponds to an example of an optical unit detecting section according to the present invention.

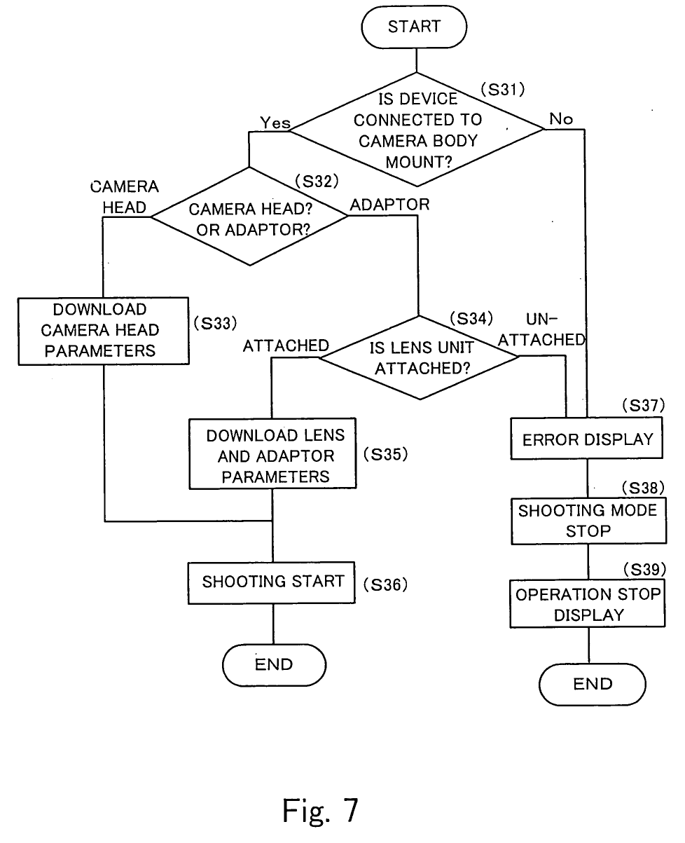

FIG. 7 is a flowchart showing processing until a photographer establishes various settings for the shooting and actually shoots.

When the power is turned on, the CPU 100b of the camera body 1_{—}b acquires the information on whether or not a device is connected from the camera body mount 171b (step S31 in FIG. 7). When a device is not connected to the camera body mount 171b (step S31 in FIG. 7: NO), the camera body CPU 100b causes the LCD 1050b to display an error message which says “DEVICE UNATTACHED”(step S37 in FIG. 7). Furthermore, the camera body CPU 100b causes various elements in the camera system 3 to stop the processing of the shooting preparation (step S38 in FIG. 7) Then, the camera body CPU 100b causes the LCD 1050b to display an error message which says “SHOOTING STOP”(step S39 in FIG. 7).

Moreover, when a device is connected to the camera body mount 171b (step S31 in FIG. 7: YES), the camera body CPU 100b acquires parameters for device types recorded in a non-volatile memory of the connected device, through a parameter communication section of the connected device and the parameter communication section 151b of the camera body 1_{—}b.

When the connected device is a camera head (step S32 in FIG. 7: CAMERA HEAD), the camera body CPU 100b acquires camera head parameters through a parameter communication section provided in the camera head and the parameter communication section 151a of the camera body 1_{—}b (step S33 in FIG. 7). The CPU 100b of the camera body 1_{—}b controls the various elements of the camera system 3 according to these parameters of each type, thus starting the shooting (step S36 in FIG. 7).

Further, when a device connected to the camera body 1_{—}b is the adaptor 1_{—}a (step S32 in FIG. 7: ADAPTOR), the information on the attachment state of the lens unit 1_{—}c detected by the lens detecting section 105a is propagated to the CPU 100b of the camera body 1_{—}b through the attachment information communication section 152a of the adaptor._{—}a and the attachment information communication section 152b of the camera body 1_{—}b.

When the lens unit 1_{—}c is not attached to the adaptor 1_{—}a (step S34 in FIG. 7: UNATTACHED), the camera body CPU 100b causes the LCD 1050b to displays an error message which says “LENS UNATTACHED”(step S37 in FIG. 7), and causes the various elements in the camera system 3 to stop the processing of the shooting preparation (step S38 in FIG. 7). Then, the camera body CPU 100b causes the LCD 1050b to display the error message which says “SHOOTING STOP”(step S39 in FIG. 7).

Further, when the lens unit 1_{—}c is attached to the adaptor 1_{—}a (step S34 in FIG. 7: ATTACHED), lens parameters are firstly transmitted from the lens unit 1_{—}c to the adaptor 1_{—}a. Subsequently, the lens parameters and the adaptor parameters are transmitted from the adaptor 1_{—}a to the camera body 1_{—}b (step S35 in FIG. 7).

As described above, when the parameters of each type are propagated to the camera body 1_{—}b, the camera body CPU 100b gives operational commands to the various elements of the camera system 3 in accordance with the parameters of each type and the various setting contents established by a photographer, thus starting the shooting (step S36 in FIG. 7).

Note that, in FIG. 7, the description has been given of the example of controlling the various elements of the camera system 3 by use of the camera body CPU 100b of the camera body 1_{—}b. However, the control over the camera system 3 may be performed by the adaptor CPU 19a of the adaptor 1_{—}a, for example. In this case, in step 34 of FIG. 7, the information on the attachment state of the lens unit 1_{—}c detected by the lens detecting section 105a is propagated to the adaptor 1_{—}a. In step S35, the following is propagated: the lens parameters from the lens unit 1_{—}c to the adaptor CPU 19a; the adaptor parameters recorded in the non-volatile memory 191a of the adaptor 1_{—}a to the adaptor CPU 19a; and the various setting contents established by the photographer from the camera body 1_{—}b to the adaptor CPU 19a. The adaptor CPU 19a gives operational commands to the various elements of the camera system 3 in accordance with these parameters of each type.

In this manner, according to the camera system 3 of the embodiment, when the lens unit 1_{—}c is not attached, the fact that the lens unit 1_{—}c is unattached is notified to the photographer before starting to shoot. Accordingly, it is possible to previously avoid a false operation to shoot without attaching the lens unit 1_{—}c.

Although the description has been given above of the camera system in which the CCD is provided as an image pickup device here, the image pickup device of the present invention may be a MOS or the like.

In addition, in recent years, a liquid lens which adjusts the refractive index of light by applying voltage to the liquid contained in a container and changing the form of the liquid surface or the like is being developed. The description was given in the above, of the example where a normal lens is used as a photographic optical system according to the present invention. However, the photographic optical system according to the present invention may be the liquid lens or the like. In this case, “drive of the photographic optical system”means an operation to apply voltage to the liquid in a manner of acting equivalently to moving a normal lens to the optical axis, and the like.

Furthermore, the description was given of the example where, by displaying the messages on the LCD, the notification section for notifying a photographer of the fact that the lens unit is unattached. However, the notification section according to the present invention may be, for example, one which gives notification by use of voice or the like.

What is claimed is:

1. An adaptor device comprising:
a mount to which an optical unit provided with a photographic optical system is attached in a freely attachable and detachable manner;
an image pickup device which obtains image data showing subject light formed through the photographic optical system;
an image transmitting section which transmits the image data acquired by the image pickup device to a camera body performing predetermined image processing based on the image data; and
a mount connector which is attached to the camera body in a freely attachable and detachable manner.

2. A camera system comprising:
an optical unit provided with a photographic optical system through which subject light passes and a first mount connector;
an adaptor provided with: a first mount which fits into the first mount connector in a freely attachable and detachable manner; an image pickup device which acquires image data showing the subject light formed through the photographic optical system; an image transmitting section which transmits the image data acquired by the image pickup device; and a second mount connector; and
a camera body provided with: an image receiving section which receives the image data transmitted by the image transmitting section; an image processing section which performs predetermined image processing based on the image data received by the image receiving section; and a second mount which fits into the second mount connector in a freely attachable and detachable manner.

3. The camera system according to claim 1, wherein the camera body includes a detecting section which detects whether what is attached to the second mount is the adaptor or a camera head having a photographic optical system, an image pickup device which acquires image data showing subject light formed through the photographic optical system and a mount connector of the same type as the second mount connector.

4. The camera system according to claim 2, wherein the camera body includes:
an optical unit detecting section which detects whether the optical unit is attached to the adaptor, when the adaptor is attached to the second mount; and
a notifying section which gives notification that the optical unit is unattached, when the optical unit is detected to be unattached by the optical unit detecting section.

5. The camera system according to claim 2, wherein the optical unit includes a storage section which stores optical information on the photographic optical system, and the camera body and/or the adaptor includes an information acquiring section which acquires the optical information stored in the storage section.

6. The camera system according to claim 1, wherein the adaptor includes a battery which supplies power.
